(19) United States
(12) Patent Application Publication
(10) Pub. No.: US 2024/0005206 A1
(43) Pub. Date: Jan. 4, 2024

(54) LEARNING DEVICE AND LEARNING METHOD

(71) Applicant: HONDA MOTOR CO., LTD., Tokyo (JP)

(72) Inventors: Takayuki Osa, Wako-shi (JP); Akinobu Hayashi, Wako-shi (JP)

(21) Appl. No.: 18/206,644

(22) Filed: Jun. 7, 2023

(30) Foreign Application Priority Data
Jun. 30, 2022 (JP) 2022-106325

(51) Int. Cl. G06N 20/00

(52) U.S. Cl. CPC G06N 20/00

(57) ABSTRACT

A learning device includes a dataset acquisition unit configured to acquire a dataset including state information and action information on which a policy is to be learned, a discrete latent variable estimation unit configured to estimate a discrete latent variable representing characteristics of features from the state information and the action information, an optimal action learning unit configured to learn an optimal action using the state information and the discrete latent variable, a value function estimation unit configured to learn an action value from the state information and the action information, and an identification unit configured to identify a discrete latent variable that maximizes the action value using a result from the optimal action learning unit and a result from the value function estimation unit.

### CROSS-REFERENCE TO RELATED APPLICATION

Priority is claimed on Japanese Patent Application No. 2022-106325, filed Jun. 30, 2022, the content of which is incorporated herein by reference.

### BACKGROUND OF THE INVENTION

### Field of the Invention

The present invention relates to a learning device and a learning method.

### Description of Related Art

Reinforcement learning has achieved remarkable successes in various applications, but most of the successes have been achieved in online learning environments where a reinforcement learning agent interacts with an environment during a learning process. Reinforcement learning generates a prediction model, for example, using a plurality of input parameters (see, for example, Patent Document 1 below).

Reinforcement learning requires time and computational cost to interact with the environment. Thus, attention has been focused on offline reinforcement learning, also called batch reinforcement learning, to reduce the number of interactions (see, for example, Non-Patent Document 1 below). The goal of offline reinforcement learning is to learn an optimal policy from a dataset collected by an arbitrary and unknown process. Recent studies have shown that offline reinforcement learning can significantly reduce the number of interactions with the environment required to achieve satisfactory performance.
[Patent Document 1] Japanese Unexamined Patent Application, First Publication No. 2020-14841
[Non-Patent Document 1] Ashvin Nair, Abhishek Gupta, Murtaza Dalai, et al., “AWAC: Accelerating Online Reinforcement Learning with Offline Datasets,” Machine Learning (cs.LG); Robotics (cs.RO); Machine Learning (stat.ML), arXiv:2006.09359 [cs.LG], 2006

### SUMMARY OF THE INVENTION

However, the performance of a policy obtained by known offline reinforcement learning algorithms highly depends on the quality of a given dataset. Recent studies have reported that offline reinforcement learning has problems with approximation errors and extrapolation errors of value functions and the like because there are no online interactions with a target environment.

Aspects of the present invention have been made in view of the above problems and it is an object of the present invention to provide a learning device and a learning method that can reduce the problems in reinforcement learning.

To solve the above problems and achieve the object, the present invention adopts the following aspects.

(1) A learning device according to an aspect of the present invention includes a dataset acquisition unit configured to acquire a dataset including state information and action information on which a policy is to be learned, a discrete latent variable estimation unit configured to estimate a discrete latent variable representing characteristics of features from the state information and the action information, an optimal action learning unit configured to learn an optimal action using the state information and the discrete latent variable, a value function estimation unit configured to learn an action value from the state information and the action information, and an identification unit configured to identify the discrete latent variable that maximizes the action value using a result from the optimal action learning unit and a result from the value function estimation unit.

(2) A learning method according to an aspect of the present invention includes an acquisition step of acquiring a dataset including state information and action information on which a policy is to be learned, an estimation step of estimating a discrete latent variable representing characteristics of features of the dataset from the state information and the action information included in the dataset, a first learning step of learning an optimal action using the state information and the estimated discrete latent variable, a second learning step of learning an action value from the state information and the action information, and an identification step of identifying the discrete latent variable that maximizes the action value using a result of learning of the first learning step and a result of learning of the second learning step.

(3) The learning method according to the above aspect (2) may further include a value function update step of putting the identified discrete latent variable into the second learning step to update the value function, a latent variable action update step of putting the updated value function into the estimation step and the first learning step to update the discrete latent variable and the optimal action, and a third learning step of repeating the value function update step and the latent variable action update step to learn the discrete latent variable and the optimal action.

(4) In the learning method according to the above aspect (2) or (3), when the learned policy is executed, not all the first learning steps may be activated, the discrete latent variable may be estimated according to a situation, and a lower policy corresponding to the estimated discrete latent variable may be sequentially selected and activated.

(5) In the learning method according to the above aspect (3), when z is the discrete latent variable, z′ is a next discrete latent variable, s is a state, s′ is a next state, Q_{w} is an estimate of a Q value parameterized by a vector w, y is a target value, r is a reward in learning, γ is a discount factor, θ is a vector representing parameters of a policy, ϕ is a vector representing parameters of a model of a posterior distribution, (z^{˜})′ is the next discrete latent variable that has been estimated, f^{π} is a function that quantifies performance of a policy π, l_{cvae} is a variational lower bound, and a is an action, the estimation step may include calculating the latent variable using

$${z}^{′} = arg {max}_{{\tilde{z}}^{′}} {Q}_{w} ( {s}^{′} , μ ( {s}^{′} , {\tilde{z}}^{′} ) ) ,$$

the value function update step may include calculating the target value y using

$$y = r + γ {min}_{j = 1 , 2} {Q}_{{w}_{j}} ( s , μ ( s , {z}^{′} ) ) ,$$

the value function update step may include updating an action value function by updating a critic that minimizes Σ∥y−Q_{w}(s,a)∥², and
the latent variable action update step may include updating a first model by updating an actor and a posterior distribution to maximize

$$\{ ℒ ( θ , ϕ ) = {\sum }_{i = 1}^{N} {f}^{π} ( {s}_{i} , {a}_{j} ) {l}_{cvae} ( {s}_{i} , {a}_{i} ; θ , ϕ ) \} .$$

According to aspects (1) to (5) above, it is possible to reduce the problems in reinforcement learning.

According to aspects (1) to (5) above, it is possible to improve learning performance by learning a discrete variable and a mixed policy.

### BRIEF DESCRIPTION OF THE DRAWINGS

FIG. 1 is a diagram for explaining an outline of reinforcement learning.

FIG. 2 is a diagram for explaining a model used in an embodiment.

FIG. 3 is a diagram showing an exemplary configuration of a learning device according to the embodiment.

FIG. 4 is a diagram showing an example of a dataset used in the embodiment.

FIG. 5 is a flowchart of an exemplary outline procedure of a learning process according to the embodiment.

FIG. 6 is a flowchart of an exemplary procedure for a learning process according to the embodiment.

FIG. 7 is a flowchart of an exemplary procedure for a process for estimating an action using a trained model according to the embodiment.

FIG. 8 is a diagram showing an example of an algorithm for learning according to the embodiment.

FIG. 9 is a diagram showing differences between methods used for comparison.

FIG. 10 is a diagram showing the results of evaluating the influence of the number of dimensions of a discrete latent variable.

FIG. 11 is a diagram showing a comparison between V2AE which is a method of the present embodiment and baseline methods in Mujoco tasks.

FIG. 12 is a diagram showing a comparison between V2AE which is the method of the present embodiment and the baseline methods in Kitchen and Adroit tasks.

FIG. 13 is a diagram showing an example of visualizing state-action pairs in a pen human-v0 task.

FIG. 14 is a diagram showing states at 20th, 40th, 60th, and 80th time steps when lower policies are activated in a pen-human-v0 task.

FIG. 15 is a diagram showing the action values of lower policies (sub-policies) in each state when the lower policies are activated in the pen-human-v0 task.

FIG. 16 is a diagram showing normalized scores and the values of a critic loss function when learning is performed using V2AE which is the method of the present embodiment and AWAC which is the method of a comparative example.

FIG. 17 is a diagram showing the results of a first episode of activation of lower policies in the pen-human-v0 task.

FIG. 18 is a diagram showing the results of a second episode of activation of lower policies in the pen-human-v0 task.

FIG. 19 is a diagram showing the results of a third episode of activation of lower policies in the pen-human-v0 task.

### DETAILED DESCRIPTION OF THE INVENTION

Hereinafter, embodiments of the present invention will be described with reference to the drawings. In the drawings used for the following description, the dimensions of members are appropriately changed such that they have recognizable sizes.

In all drawings for explaining the embodiments, the same reference numerals are used for components with the same functions and repetitive description will be omitted.

“Based on XX” in the present application means “based on at least XX” and includes the case where something is based on another element in addition to XX. “Based on XX” is not limited to the case where XX is directly used and also includes the case where something is based on a result of an operation or processing performed on XX. “XX” is an arbitrary element (for example, arbitrary information).

### Outline of Reinforcement Learning

First, an outline of reinforcement learning will be described.

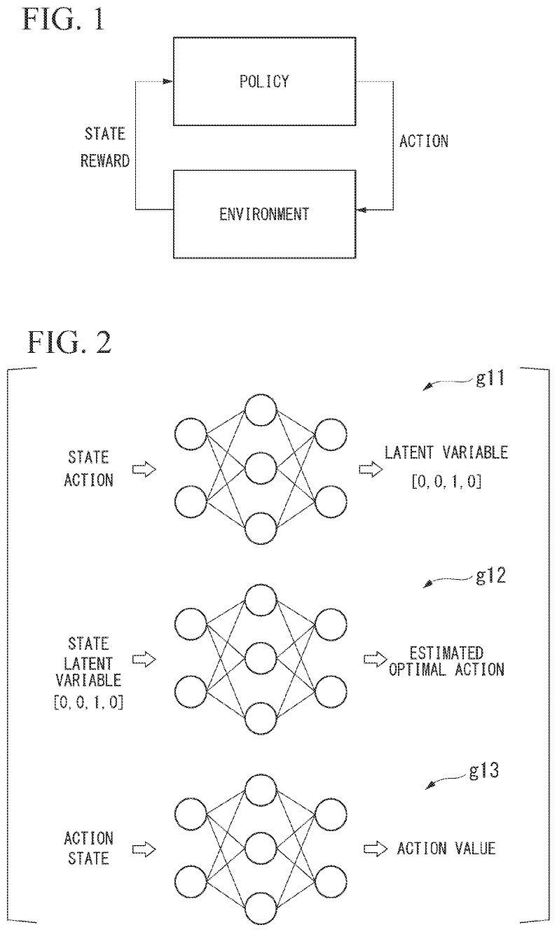

FIG. 1 is a diagram for explaining an outline of reinforcement learning. In reinforcement learning, for example, a “state” is acquired from an environment and the acquired “state” and a “reward” are input to a policy as shown in FIG. 1. Then, in reinforcement learning, the policy estimates an “action” based on the input “state” and “reward.” Then, in reinforcement learning, the estimated “action” is performed in the environment and its state is acquired again.

### Description of Models

In the present embodiment, the following three models are used for reinforcement learning.

FIG. 2 is a diagram for explaining models used in the present embodiment. Symbol g11 indicates an image showing the input/output of an encoder which is a first model. As indicated by symbol g11, the encoder receives a state and an action as inputs and estimates and outputs a discrete latent variable (for example, [0, 0, 1, 0]) for the given state and action. In the following description, the “discrete latent variable” will also be referred to as a “latent variable.”

Symbol g12 indicates an image showing the input and output of a lower policy which is a second model. As indicated by symbol g12, the lower policy receives the estimated latent variable and the state as inputs and estimates and outputs an optimal action for the given state and latent variable.

Symbol g13 indicates an image showing the input and output of an action-value function which is a third model. As indicated by symbol g13, the action-value function receives the state and the action as inputs and estimates and outputs an action value for the given state and action.

### Exemplary Configuration of Learning Device

Next, an exemplary configuration of a learning device 1 that performs learning will be described.

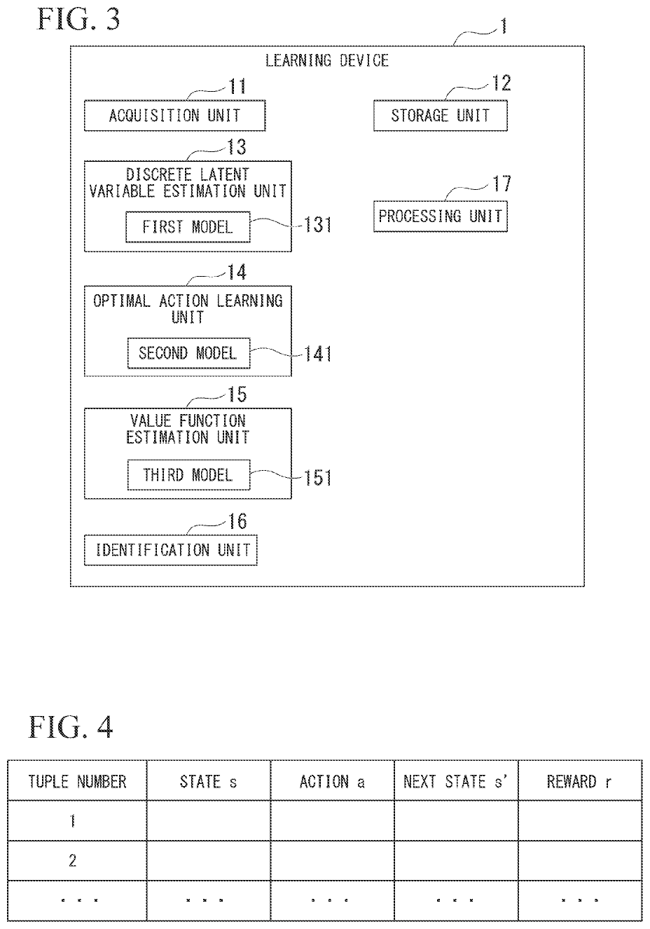

FIG. 3 is a diagram showing an exemplary configuration of a learning device according to the present embodiment. As shown in FIG. 3, the learning device 1 includes, for example, an acquisition unit 11, a storage unit 12, a discrete latent variable estimation unit 13, an optimal action learning unit 14, a value function estimation unit an identification unit 16, and a processing unit 17.

The acquisition unit 11 acquires a dataset including rewards, state information, and action information on which a policy is to be learned. If the dataset does not contain rewards, it is necessary to recalculate only rewards according to a task to be learned.

The storage unit 12 stores datasets. The storage unit 12 stores a program that the processing unit 117 uses for processing, a predetermined number of times, and the like.

The discrete latent variable estimation unit 13 includes the first model (the encoder) 131. The discrete latent variable estimation unit 13 estimates a discrete latent variable representing the characteristics of features from the state information and the action information.

The optimal action learning unit 14 includes the second model (the lower policy) 141. The optimal action learning unit 14 learns an optimal action by performing estimation with the second model 141 that estimates an action using the state information and the discrete latent variable.

The value function estimation unit 15 includes the third model (the action-value function) 151. The value function estimation unit 15 learns an action value by updating the third model 151 that estimates the action value from the state information and the action information.

The identification unit 16 identifies a discrete latent variable that maximizes the action value using the result from the optimal action learning unit and the result from the value function estimation unit.

The processing unit 17 initializes the first model 131, the second model 141, and the third model 151 at the start of learning. The processing unit 17 extracts some tuples of state s, action a, next state s′, and reward r from the dataset.

### Example of Dataset

Next, an example of a dataset will be described.

FIG. 4 is a diagram showing an example of a dataset used in the present embodiment. As shown in FIG. 4, the dataset consists of tuples of four elements, for example, state s, action a, next state s′, and reward r.

### Exemplary Procedure for Learning Process

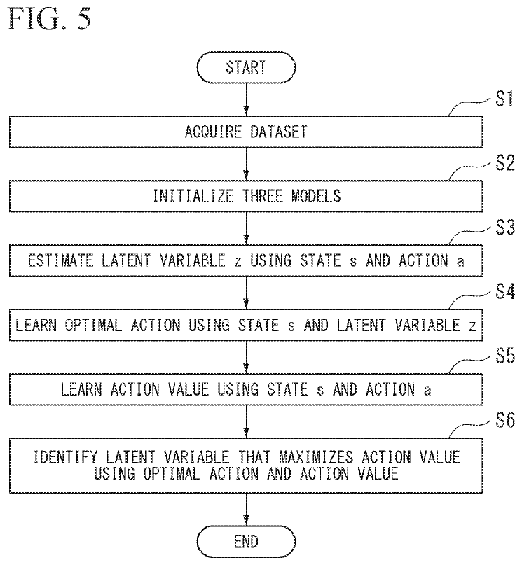

Next, an exemplary procedure for a learning process will be described. First, an outline of the learning process will be described using FIG. 5 and also with reference to FIG. 2. FIG. 5 is a flowchart of an exemplary outline procedure of a learning process according to the present embodiment.

(Step S1) The acquisition unit 11 acquires a dataset including state information and action information on which a policy is to be learned in advance and stores the acquired dataset in the storage unit 12 (acquisition step).

(Step S2) The processing unit 17 initializes the first model 131, the second model 141, and the third model 151.

(Step S3) The discrete latent variable estimation unit 13 estimates a discrete latent variable representing the characteristics of features using the state information and action information included in the dataset and the first model 131 (estimation step).

(Step S4) The optimal action learning unit 14 learns an optimal action using the state information, the estimated discrete latent variable, and the second model 141 (first learning step).

(Step S5) The value function estimation unit 15 learns an action value using the state information, the action information, and the third model 151 (second learning step).

(Step S6) The identification unit 16 identifies a discrete latent variable that maximizes the action value using the result of learning in step S4 and the result of learning in step S5 (identification step).

Next, an exemplary procedure for a learning process including updating the models will be described.

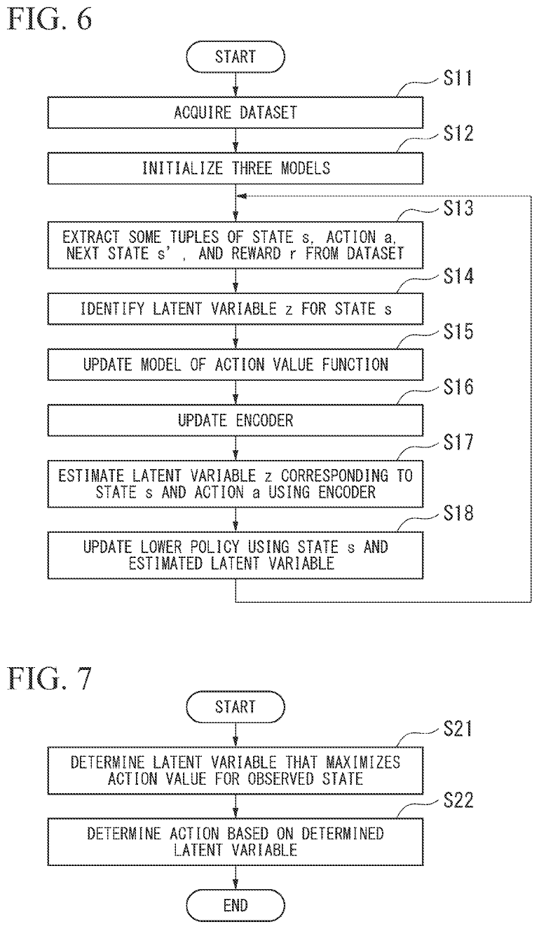

FIG. 6 is a flowchart of an exemplary procedure for a learning process according to the present embodiment. The learning device 1 performs learning through the following process for each action. The learning device 1 repeats the following process a predetermined number of times.

(Step S11) The acquisition unit 11 acquires a dataset in advance and stores the acquired dataset in the storage unit 12 (acquisition step).

(Step S12) The processing unit 17 initializes the first model 131, the second model 141, and the third model 151.

(Step S13) The processing unit 17 extracts some tuples of state s, action a, next state s′, and reward r from the dataset. The processing unit 17 selects a plurality of tuples, the number of which ranges, for example, from 256 to 1024.

(Step S14) The identification unit 16 identifies a latent variable z that maximizes the action value for the state s.

(Step S15) The value function estimation unit 15 trains and updates the third model 151 (the action-value function) using the latent variable z identified in step S14.

(Step S16) The discrete latent variable estimation unit 13 trains and updates the first model 131 (the encoder) that estimates a latent variable corresponding to the state s and the action a.

(Step S17) The discrete latent variable estimation unit 13 estimates a latent variable z corresponding to the state s and the action a using the first model 131.

(Step S18) The optimal action learning unit 14 trains and updates the second model 141 (the lower policy) using the state s and the latent variable estimated in step S16.

Each state s selected in step S13 continues to be used in steps S14 to S18. In the process, the same operation is simultaneously performed on a plurality of states s and each model is updated based on the results.

### Exemplary Procedure for Process for Estimating Action

Next, an exemplary procedure for a process for estimating an action using a trained model will be described.

FIG. 7 is a flowchart of an exemplary procedure for a process for estimating an action using a trained model according to the present embodiment.

(Step S21) The learning device 1 determines a latent variable that maximizes the action value for an observed state using the trained first model 131.

(Step S22) The learning device 1 determines an action using the trained second model 141 based on the determined latent variable.

### Description of Learning Method

The principles of a learning method used in the present embodiment will be described below.

First, reinforcement learning under a Markov decision process (MDP) defined by a tuple of the following expression will be considered.

( [symbol] , [symbol] , [symbol] ,r,γ,d) (1)

In expression (1), S is a state space, A is an action space, P(sₜ₊₁|sₜ,aₜ) is a transition probability density, r(s, a) is a reward function, γ is a discount factor, and d(s₀) is a probability density of an initial state.

A policy π(a|s) in the following expression (2) is defined as a conditional probability density function of an action for a given state. A double-line letter R is a set of all real values.

π(a|s): [symbol] × [symbol] [symbol] [symbol] (2)

The objective of reinforcement learning is to identify a policy that maximizes an expected cumulative discounted reward of the following expression (3).

[symbol]

[R₀|π] (3)

Here, Rₜ is given by the following expression (4).

Rᵣ=Σₖ₌ₜ^{T}γ^{k-t}r(sₖ,aₖ) (4)

A Q function Q^{π}(s, a) is the expected value of the reward when starting from a state s, taking an action a, and following the policy π under the given Markov decision process. Offline reinforcement learning assumes a dataset of the following expression (5) consisting of states, actions, and rewards collected by an unknown policy.

[symbol]

={(sᵢ,aᵢ,rᵢ)}ᵢ₌₁^{N} (5)

The goal of offline reinforcement learning is to obtain a policy that maximizes the expected value of the reward using the dataset D.

Here, the problem of offline reinforcement learning is formulated as follows. Given a dataset D (of expression (5)), the goal of a learning process is to obtain, without interacting with an environment, a policy π that maximizes a reward obtained by interacting with the environment.

In offline reinforcement learning, the expected value of the reward is evaluated with respect to states stored in a given dataset. Thus, the objective function is given by the following expression (6).

J(π)= [symbol] [f^{π}(s,a)] (6)

In expression (6), f^{π} is a function that quantifies the performance of the policy π. In reinforcement learning, there are several choices for f as shown in Reference 1. For example, a TD3 method (see, for example, Reference 2) adopts an action-value function f^{π}(s, a)=Q^{π}(s, a) and an advantage actor critic (A2C) method adopts an advantage function f^{π}(s, a)=A^{π}(s, a). The A2C method is a variant of asynchronous advantage actor critic (A3C) with the asynchronous element removed from A3C.

Reference 1: John Schulman, Philipp Moritz, Sergey Levine, Michael Jordan, and Pieter Abbeel, “High-dimensional continuous control using generalized advantage estimation,” In Proceedings of the International Conference on Learning Representations (ICLR), 2016.

Reference 2: Scott Fujimoto and Shixiang Shane Gu, “A minimalist approach to offline reinforcement learning,” Advances in Neural Information Processing Systems (NeurIPS), 2021.

Other previous studies have adopted calculations involving exponential functions, which are expressed by the following expression (7) or (8).

f^{π}(s,a)=exp( [symbol] ^{π}(s,a)) (7)

f^{π}(s,a)=exp(A^{π}(s,a)) (8)

Without loss of generality, it is assumed that the objective function is given by expression (6). Previous studies often propose an objective function with a regularization term added to learn a policy, whereas the present embodiment derives a variational lower bound of the simple objective function for offline reinforcement learning as an objective function.

### Mixed Policy

The present embodiment introduces a model of the following expression (9) that can be represented by a multimodal distribution. The model given by expression (9) is a policy mixture model.

$$π ( a \vert s ) = {\sum }_{{z ∈ Z}^{}} π ( z \vert s ) π ( a \vert s , z ) \qquad ( 9 )$$

In expression (9), z is a discrete latent variable, π(z|s) is an upper policy that determines the latent variable, and π(a|s,z) is a lower policy that determines an action for given s and z. It is assumed that the lower policy π(a|s,z) is a deterministic policy.

Thus, the lower policy deterministically determines an action for given s and z as a=μ_{θ}(s,z). μ_{θ}(s,z) is parameterized by a vector θ. Further, the upper policy π(a|s) determines the latent variable as shown in the following expression (10).

$$z = arg {max}_{{z}^{′}} ( s , {μ}_{θ} ( s , {z}^{′} ) ) \qquad ( 10 )$$

In expression (10), Q_{w}(s,a) is an estimate of a Q value parameterized by a vector w.

### Learning of Mixed Policy by Maximizing Variational Lower Bound

Here, when f^{π}(s, a)>0 for arbitrary s and a, a variational lower bound of log(J(π)) can be obtained using Jensen's inequality as shown in the following expressions (11) to (13).

$$log J ( π ) = log \int {d}^{β} ( s ) π ( a \vert s ) f ( s , a ) dsda = log \int {d}^{β} ( s ) β ( a \vert s ) \frac{π ( a \vert s )}{β ( a \vert s )} f ( s , a ) dsda \qquad ( 11 )$$

$$Expression ( 11 )$$

$$\geq \int d ( s ) β ( a \vert s ) log \frac{π ( a \vert s )}{β ( a \vert s )} f ( s , a ) dsda \qquad ( 12 )$$

$$Expression ( 12 )$$

$$= {𝔼}_{( s , a ) ∼ D} [ log π ( a \vert s ) f ( s , a ) ] - {𝔼}_{( s , a ) ∼ D} [ log β ( a \vert s ) f ( s , a ) ] \qquad ( 13 )$$

The second term of expression (13) is independent of the policy π. Thus, to maximize the variational lower bound of J(π) is to maximize the following expression (14).

Σᵢ₌₁^{N} log π(aᵢ|sᵢ)f(sᵢ,aᵢ) (14)

When f^{π}(s, a)=exp(A^{π}(s, a)) is adopted and the policy is Gaussian, the resulting algorithm is equivalent to AWAC (of Non-Patent Document 1). Further analysis of the objective function of expression (13) in order to employ a mixed policy using a discrete latent variable yields the following expression (15).

log π(aᵢ|sᵢ)=D_{KL}(q(z|sᵢ,aᵢ)∥p(z|sᵢ,aᵢ))+D_{KL}(q(z|sᵢ,aᵢ))∥p(z|sᵢ))+ [symbol] _{z˜p(z)}[log π(aᵢ|sᵢ,z)] (15)

Since D_{KL}(q(z|s,a)∥p(z|s,a))>0 in expression (15), transformation of the variational lower bound as used in the conditional VAE (see Reference 3) yields the following expression (16). p and q are probabilities. The term q_{ϕ}(z|sᵢ,aᵢ) indicates that q is parameterized by ϕ (a variational parameter). The term π_{θ}(aᵢ|sᵢ,z) indicates that π is parameterized by θ.

log π_{θ}(aᵢ|sᵢ)=D_{KL}(q_{ϕ}(z|sᵢ,aᵢ)∥p(z|s))+ [symbol] _{z˜p(z)}[log π_{θ}(aᵢ|sᵢ,z)] (16)

Reference 3: Kihyuk Sohn, Honglak Lee, and Xinchen Yan, “Learning structured output representation using deep conditional generative models,” In Advances in Neural Information Processing Systems (NeurIPS), 2015.

In Previous studies, it is often assumed that z is statistically independent of s. That is, p(z|s)=p(z) is often used in previous studies. On the other hand, in the framework of the present embodiment, p(z|s) should represent the behavior of the upper policy π_{θ}(z|s) in expression (10). However, since it is difficult to accurately express the upper policy π_{θ}(z|s) of expression (10), the present embodiment approximates p(z|s) using a softmax distribution given by the following expression (17).

$$p ( z \vert s ) = \frac{exp ( ( s , μ ( s , z ) ) )}{{\sum }_{z ∈ Z} exp ( {Q}_{w} ( s , μ ( s , z ) ) )} \qquad ( 17 )$$

Since double clipped Q-learning (see Reference 4) is adopted, the following expression (18) is obtained.

Reference 4: Scott Fujimoto, Herke van Hoof, and David Meger, “Addressing function approximation error in actor-critic methods,” In Proceedings of the International Conference on Machine Learning (ICML), pages 1587-1596, 2018.

$$( s , μ ( s , z ) ) = {min}_{j = 1. 2} ( s , μ ( s , z ) ) \qquad ( 18 )$$

Here, the second term of expression (16) is approximated as a mean squared error as in the standard implementation of a VAE. Based on expressions (14) and (16), the present embodiment trains a mixed deterministic policy by maximizing an objective function as shown in expression (19). In expression (19), 0 is a vector representing the parameters of the policy, ϕ is a vector representing the parameters of the model of a posterior distribution, F is a function that quantifies the performance of the policy π, l_{cvae} is the (conditional) variational lower bound, and a is the action.

$$ℒ ( θ , ϕ ) = {\sum }_{i = 1}^{N} {f}^{π} ( {s}_{i} , {a}_{j} ) {l}_{cvae} ( {s}_{i} , {a}_{j} ; θ , ϕ ) \qquad ( 19 )$$

This objective function can be regarded as a weighted maximum likelihood method. Offline reinforcement learning in known methods such as BCQ (see Reference 5) and FischerBRC (see Reference 6) utilize variational auto-encoders (VAEs) to obtain dataset-constrained policies. Latent variables learned by the VAEs used in such methods are based on the density of state-action pairs in a given dataset.

Reference 5: Scott Fujimoto, David Meger, and Doina Precup, “Off-policy deep reinforcement learning without exploration,” In Proceedings of the International Conference on Machine Learning (ICML), pages 2052-2062, 2019.

Reference 6: Ilya Kostrikov, Rob Fergus, Jonathan Tompson, and Ofir Nachum, “Offline reinforcement learning with fisher divergence critic regularization,” In Proceedings of the International Conference on Machine Learning (ICML), 2021.

On the other hand, the approach of the present embodiment learns a latent variable that maximizes the lower bound of the objective function. Thus, the method of the present embodiment differs from the known methods in the meaning of the learned latent variable. The known methods learn continuous latent variables, whereas the method of the present embodiment learns a discrete latent variable.

The approach of the present embodiment can be regarded as dividing the state-action space by learning discrete latent variables.

The known method TD3-BC (see Non-Patent Document 1) recommends a policy that imitates actions contained in a given dataset, regardless of the quality of the actions.

However, in offline reinforcement learning, a given dataset may contain samples obtained by various actions and it is not appropriate to force a policy to reproduce arbitrary actions in a dataset.

Therefore, in the present embodiment, the policy π_{θ}(a|s,z) is encouraged to imitate state-action pairs with the same values of z. Thus, in the present embodiment, the policy π_{θ}(a|s,z) is not forced to imitate actions with different values of z.

The objective function of the present embodiment includes a term that reconstructs state-action pairs with adaptive weights and does not have a term associated with extrapolation such as the following expression (20) in the known method TD3-BC. Thus, in the present embodiment, actions are sampled and evaluated within a distribution of given data and actions out of the distribution of the given data are not evaluated.

[symbol]

[ [symbol] (s,μ(s))] (20)

### Estimation of Q Function for Mixed Policy

Next, a method of estimating a Q function for a mixed policy will be described.

Since expression (9) adopts a mixed policy, the estimation of the Q function is based on an operator. This slightly differs from a standard Bellman operator. Critic learning in the framework of the present embodiment is performed based on the operator of the following expression (21).

$$\\ \begin{matrix}{𝒯}_{𝓏} {Q}_{𝓏} = r ( s , a ) + γ {𝔼}_{{s}^{′}} [ {max}_{{𝓏}^{′}} {Q}_{𝓏} ( {s}^{′} , μ ( {s}^{′} , {𝓏}^{′} ) ) ] & ( 21 )\end{matrix}$$

A T_{z} operator in expression (21) will be referred to as a latent-max-Q operator. The following first and second theorems that support the algorithm of the present embodiment can be proved as follows.

### I. First Theorem

In tabular setting, the T_{z} operator is a contraction operator in the L_{∞} norm. Accordingly, with repeated applications of the T_{z} operator, any initial Q-function converges to a unique fixed point.

### II. Second Theorem

Let Q_{z} be the unique fixed point obtained by the first theorem, select a latent variable z as shown in the following expression (22), and let π_{z} be a policy that outputs an action given by μ(s, z). Then, Q_{z} is a Q function corresponding to π_{z}.

$$\\ \begin{matrix}𝓏 = arg {max}_{{𝓏}^{′}} Q ( s , μ ( s , {𝓏}^{′} ) ) & ( 22 )\end{matrix}$$

Here, a proof of the second theorem will be described. The expression (21) is rearranged to obtain the following expression (23).

[symbol]

=r(s,a)+γ [symbol] ₛ, [symbol] _{a˜π}_{_{z}}[ [symbol] (s,a)] (23)

Thus, Q_{z} is a Q function corresponding to π_{z} since Q_{z} is a unique fixed point of T_{z} by definition.

Based on the second theorem, the latent-max-Q operator is applied to estimate a Q function. In the present embodiment, double clipped Q-learning is adopted as described above. Thus, given a dataset D, critic learns by minimizing the following expression (24).

$$\\ \begin{matrix}ℒ ( {w}_{i} ) = {\sum }_{( {s}_{i} , {a}_{i} , {s}_{i}^{′} , {r}_{i} ) ∈ 𝒟} {‖ {Q}_{{w}_{i}} ( {s}_{i} , {a}_{i} ) - {y}_{i} ‖}^{2} & ( 24 )\end{matrix}$$

For j=1 and 2, a target value is calculated as shown in the following expression (25).

$$\\ \begin{matrix}{y}_{i} = {r}_{i} + γ {max}_{{𝓏}^{′} ∈ ℨ} {min}_{j = 1 , 2} {Q}_{{w}_{j}} ( {s}^{′} , μ ( {s}^{′} , {𝓏}^{′} ) ) & ( 25 )\end{matrix}$$

### Implementation

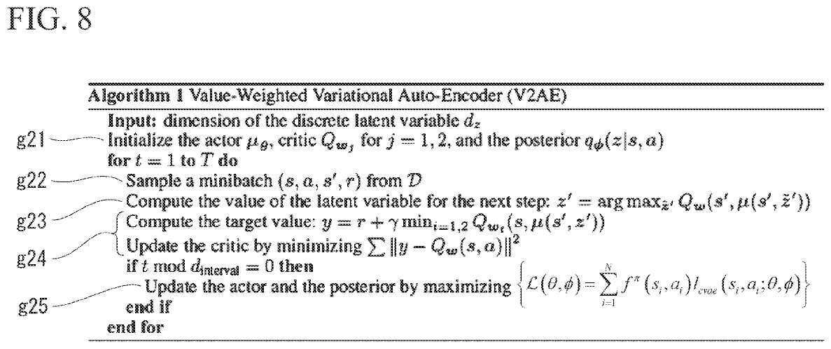

Hereinafter, the method of the present embodiment will be referred to as a value-weighted variational auto-encoder (V2AE). This algorithm is summarized in FIG. 8. FIG. 8 is a diagram showing an example of the algorithm for learning according to the present embodiment. In FIG. 8, the processing of symbol g21 corresponds to the processing of step S12 in FIG. 6. The processing of symbol g22 corresponds to the processing of step S13 in FIG. 6. The processing of symbol g23 corresponds to the processing of step S14 in FIG. 6 and calculates a latent variable using the following expression (26). The processing of symbol g24 corresponds to the processing of step S15 in FIG. 6 and calculates a target value y using the following expression (27) and updates a critic that minimizes the following expression (28). The processing of symbol g25 corresponds to the processing of step S15 in FIG. 6 and updates an actor and a posterior distribution to maximize the following expression (29). In expression (26), (z^{˜})′ is a symbol used to consider max for all possible discrete latent variables and indicates an estimated next latent variable.

$$\\ \begin{matrix}{𝓏}^{′} = arg {max}_{{\tilde{𝓏}}^{′}} {Q}_{w} ( {s}^{′} , μ ( {s}^{′} , {\tilde{𝓏}}^{′} ) ) & ( 26 )\end{matrix}$$

$$\\ \begin{matrix}y = r + γ {min}_{j = 1 , 2} {Q}_{{w}_{j}} ( s , μ ( {s}^{′} , {𝓏}^{′} ) ) & ( 27 )\end{matrix}$$

$$\\ \begin{matrix}\sum {‖ y - {Q}_{w} ( s , a ) ‖}^{2} & ( 28 )\end{matrix}$$

$$\\ \begin{matrix}\{ ℒ ( θ , ϕ ) = {\sum }_{i = 1}^{N} {f}^{π} ( {s}_{i} , {a}_{i} ) {l}_{cvae} ( {s}_{i} , {a}_{i} ; θ , ϕ ) \} & ( 29 )\end{matrix}$$

Thus, in the present embodiment, the discrete latent variable estimation unit 13 calculates the latent variable using expression (26), the value function estimation unit 15 calculates the target value y using expression (27), updates the third model of the action-value function by updating the critic that minimizes expression (28), and updates the first model by updating the actor and the posterior distribution to maximize expression (29).

The algorithm shown in FIG. 8 is an example and the present invention is not limited to this.

Similar to TD3, the actor is updated once after the critic is updated. In the algorithm, dinterval=2. For example, a Gumbel-softmax method (see, for example, Reference 7) was used to model the discrete latent variable. State normalization used in TD3+BC was used.

Reference 7: Eric Jang, Shixiang Gu, and Ben Poole, “Categorical reparameterization with gumbel-softmax,” In Proceedings of the International Conference on Learning Representations (ICLR), 2017.

As a result of preliminary experiments, it was found that, when f^{π}(s, a)=exp(βA^{π}(s, a)) in expression (19), the scaling factor has a nontrivial effect on performance and the optimal value of β differs for each task. Therefore, to avoid changing the scaling parameter for each task, normalization of the advantage function was used as shown in the following expression (30).

$$\\ \begin{matrix}{f}^{π} ( s , a ) = exp ( \frac{α ( {A}^{π} ( s , a ) - {max}_{( \tilde{s} , \tilde{a} ) ∈ {𝒟}_{batch}} {A}^{π} ( \tilde{s} , \tilde{a} ) )}{( {max}_{( \tilde{s} , \tilde{a} ) ∈ {𝒟}_{batch}} {A}^{π} ( \tilde{s} , \tilde{a} ) - {min}_{( \tilde{s} , \tilde{a} ) ∈ {𝒟}_{batch}} {A}^{π} ( \tilde{s} , \tilde{a} ) )} ) & ( 30 )\end{matrix}$$

In expression (30), D_{batch} is a minibatch sampled from a given dataset D and a is a constant, which is here set to α=10.

In V2AE which is the method of the present embodiment, the policy is given as a mixture of deterministic lower policies. A lower policy is selected in a deterministic manner as shown in expression (10). Thus, the mixed policy in the framework of the present embodiment is deterministic. If a deterministic policy is used, the critic may overfit narrow peaks. On the other hand, the policy of the present embodiment is deterministic and therefore also adopts a technique called target policy smoothing used in TD3.

Thus, the target value of expression (25) is corrected as shown in the following expression (31).

$$\\ \begin{matrix}{y}_{i} = {r}_{i} + γ {max}_{{z}^{′} ∈ ℨ} {min}_{j = 1 , 2} {Q}_{{w}_{j}^{′}} ( {s}^{′} , {μ}_{{θ}^{′}} ( {s}^{′} , {z}^{′} ) + {ε}_{clip} ) & ( 31 )\end{matrix}$$

In expression (31), ε_{clip} is given by the following expression (32).

ε_{clip}=min(max(ε,−c),c) where ε˜ [symbol] (0,σ) (32)

In expression (32), a constant c defines a noise range.

### Evaluation

Next, examples of the results of confirming the effects of a critic dropout layer and the effects of learning of a mixed policy according to the method of the present embodiment will be described. In the evaluation, a workstation and a physical simulator were used.

First, the method of the present embodiment was evaluated with benchmark tasks of D4RL (see Reference 8). As baselines, TD3-BC, CQL (see Reference 9), AWAC (see Non-Patent Document 1), easyBCQ (see Reference 10), and EDAC (see Reference 11) were evaluated. In AWAC implementation, state normalization and double clipped Q-learning were used, similar to TD3+BC, and the advantage function was also normalized.

Reference 8: Justin Fu, Aviral Kumar, Ofir Nachum, George Tucker, and Sergey Levine, “D4rl: Datasets for deep data-driven reinforcement learning,” arXiv, 2020

Reference 9: Aviral Kumar, Aurick Zhou, George Tucker, and Sergey Levine, “Conservative q-learning for offline reinforcement learning,” In Advances in Neural Information Processing Systems (NeurIPS), 2020.

Reference 10: David Brandfonbrener, William F. Whitney, Raj esh Ranganath, and Joan Bruna, “Offline rl without off-policy evaluation,” In Advances in Neural Information Processing Systems (NeurIPS), 2021.

Reference 11: Gaon An, Seungyong Moon, Jang-Hyun Kim, and Hyun Oh Song, “Uncertainty-based offline reinforcement learning with diversified q-ensemble,” In Advances in Neural Information Processing Systems (NeurIPS), 2021.

In this way, the difference in the evaluation between AWAC and V2AE in the method of the present embodiment represents the difference in policy model. Double clipped Q-learning was also used in easyBCQ.

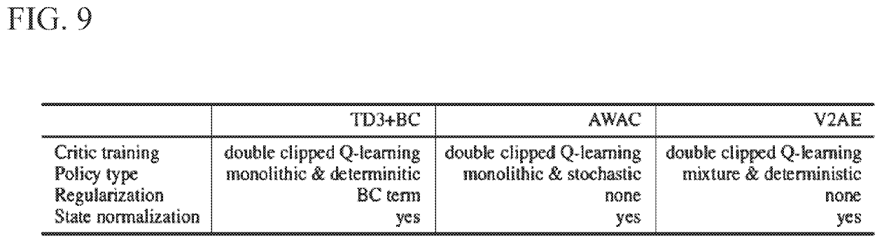

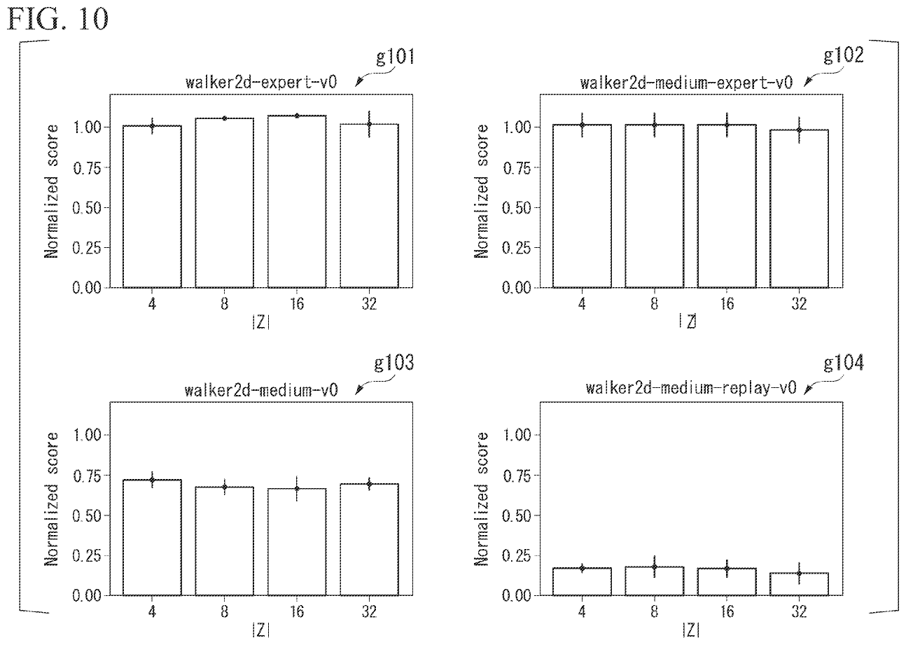

FIG. 9 is a diagram showing differences between methods used for comparison. In the evaluation, the baseline methods were performed again on a D4RL-v0 dataset. The results of Kitchen and Adroit tasks of the EDAC method were omitted.

First, the influence of the number of dimensions of the discrete latent variable was evaluated.

FIG. 10 is a diagram showing the results of evaluating the influence of the number of dimensions of the discrete latent variable. The evaluation in FIG. 10 involves an average normalized score over 10 past test episodes and five seeds and shows the performance after 1 million updates. The horizontal axis represents the absolute value of the latent variable z and the vertical axis represents the average normalized score.

A graph g101 indicates the average normalized score for “walker2d-expert” in the D4RL-v0 dataset. A graph g102 indicates the average normalized score for “walker2d-medium-expert” in the D4RL-v0 dataset. A graph g103 indicates the average normalized score for “walker2d-medium” in the D4RL-v0 dataset. A graph g104 indicates the average normalized score for “walker2d-medium-replay” in the D4RL-v0 dataset.

As shown in FIG. 10, an absolute value of the latent variable of |Z|=8 consistently showed satisfactory performance and thus |Z|=8 was adopted in the following evaluations.

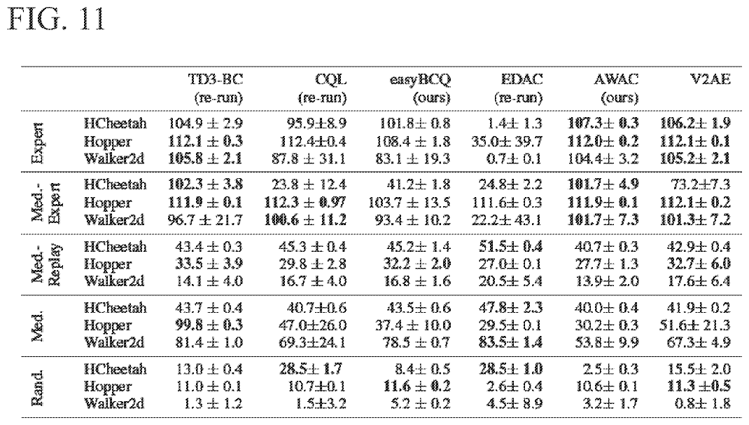

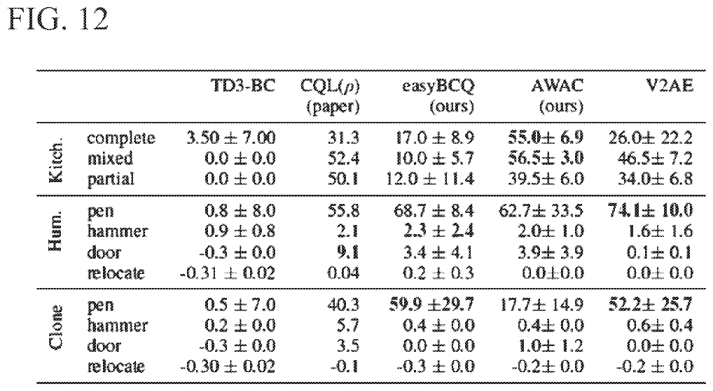

Comparisons between V2AE which is the method of the present embodiment and the baseline methods are shown in FIGS. 11 and 12. The following evaluations also use the D4RL-v0 dataset.

FIG. 11 is a diagram showing a comparison between V2AE which is the method of the present embodiment and the baseline methods in Mujoco tasks. In FIG. 11, HCheetah stands for Half Cheetah. See Non-Patent Document 1 for Half Cheetah, Hopper, Walker2d, etc. The results in FIG. 11 show the average normalized score over 10 past test episodes and five seeds.

FIG. 12 is a diagram showing a comparison between V2AE which is the method of the present embodiment and the baseline methods in Kitchen and Adroit tasks. In FIG. 12, the Kitchen task is abbreviated as “Kitch.” and the human task is abbreviated as “Hum.”. “complete,” “partial,” and “mixed” indicate the difficulty levels of the Mujoco tasks, with “complete” indicating the highest difficulty level and “mixed” indicating the lowest difficulty level. “pen,” “Hammer,” “door,” and “relocate” indicate datasets (see, for example, Reference 12). The results of FIG. 12 are those for the Kitchen task and the Adroit task, showing the average normalized score over 10 past test episodes and five seeds. For kitchen-complete-v0 and *-human-v0, the number of data points is about 10,000 and thus the performance after 10,000 updates is shown. Since these datasets have about 10,000 data points, the performance after 10,000 updates is shown. For other datasets, the performance after 1 million updates is shown.

Reference 12: Wenxuan Zhou, Sujay Bajracharya, David Held, “PLAS: Latent Action Space for Offline Reinforcement Learning,” 4th Conference on Robot Learning (CoRL 2020), Cambridge MA, USA, 2020

As shown in FIG. 11, V2AE which is the method of the present embodiment have achieved performance comparable to TD3+BC and EDAC which are the latest offline reinforcement learning methods in the Mujoco tasks.

As shown in FIG. 12, the superiority of V2AE which is the method of the present embodiment appears more prominently in the Kitchen and Adroit tasks. The V2AE which is the method of the present embodiment clearly outperforms the baseline methods in these tasks. The difference between AWAC and V2AE is associated with the influence of different policy representations. V2AE which is the method of the present embodiment has showed equal or better performance compared to AWAC.

From the results of FIGS. 11 and 12, it can be seen that the use of the mixed policy is effective in reinforcement learning. In particular, V2AE which is the method of the present embodiment have showed the best performance in the Adroit and Kitchen tasks.

### Visualization of Learned Latent Variable

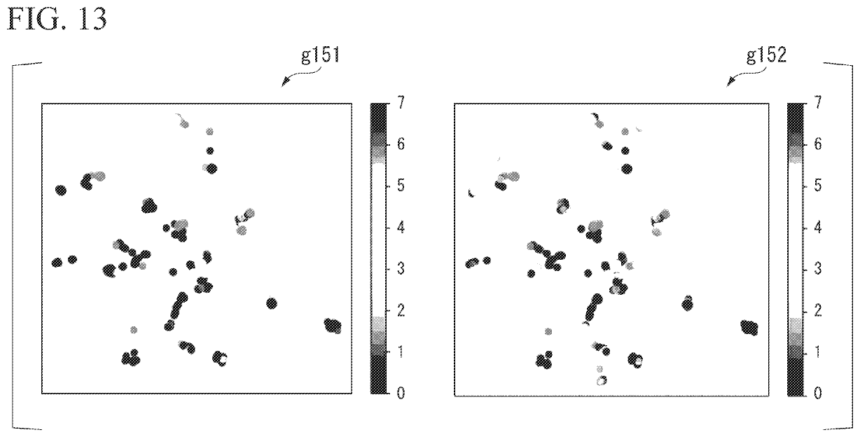

Next, an example of visualizing the learned latent variable will be described. FIG. 13 is a diagram showing an example of visualizing state-action pairs in a pen human-v0 task. In FIG. 13, the shading of circles indicates the value of the latent variable. An image g151 is an example of visualizing the distribution of a latent variable sampled from q_{ϕ}(s, a). An image g152 is an example of visualizing the distribution of the latent variable given by z=arg max {Q_{w}(s,μ(s, z))}.

The state-action pairs were reduced in dimensionality using t-SNE. The distribution of latent variable values shows how the state-action space is divided. The KL information quantity D_{KL}(q(z|s,a)∥p(z|s)) was minimized as a part of the objective function. Therefore, samples generated from q(z|s,a) and p(z|s) are to be similar.

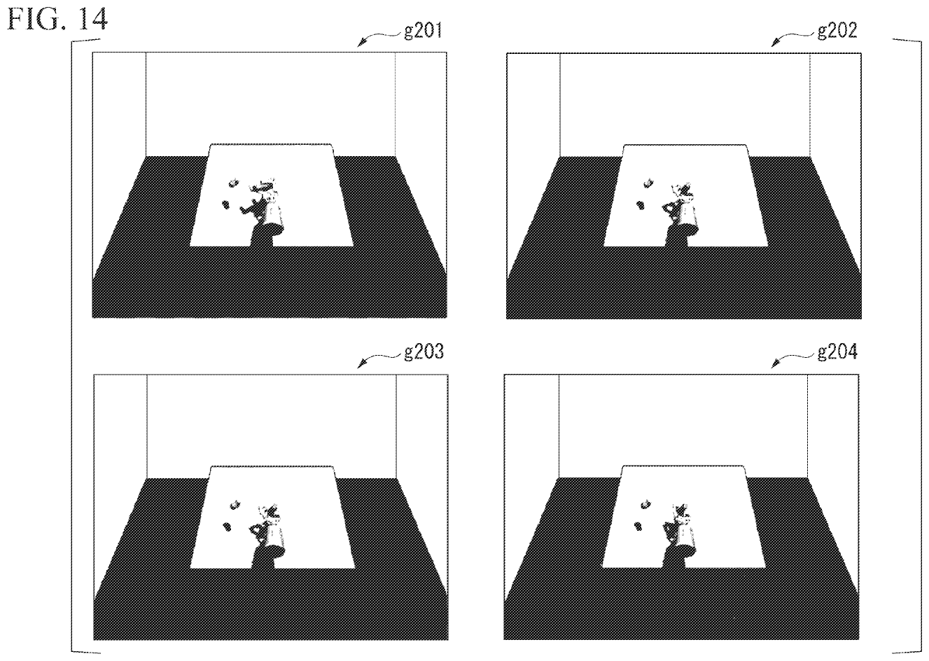

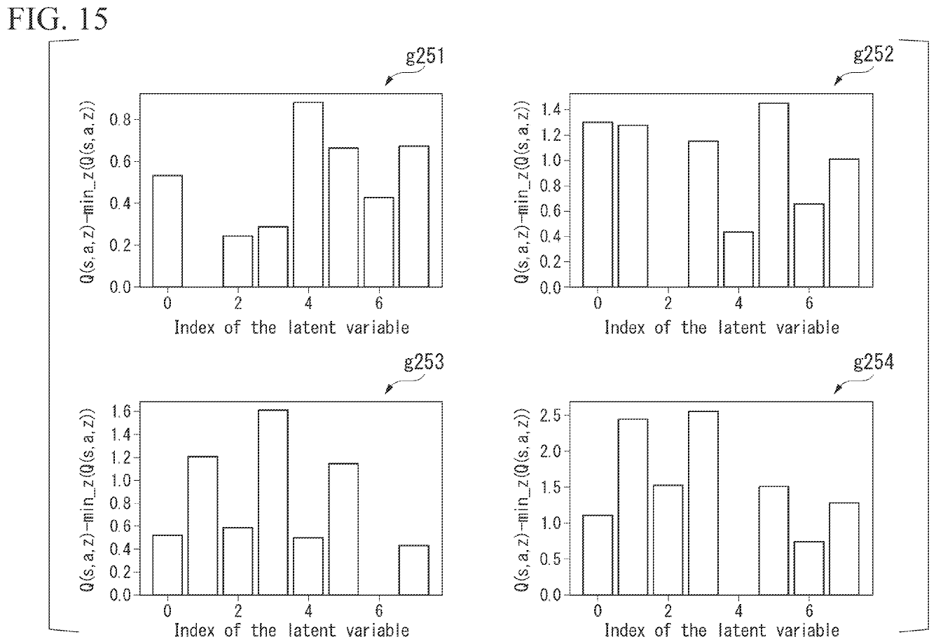

FIGS. 14 to 16 show how lower policies are activated in the pen-human-v0 task. The task is to hold a pen at a correct angle. FIG. 14 is a diagram showing states at the 40th, 60th, and 80th time steps when lower policies are activated in the pen-human-v0 task. FIG. 15 is a diagram showing action values of lower policies (sub-policies) in each state when the lower policies are activated in the pen-human-v0 task. In FIGS. 14 and 15, images g201 and g251 indicate states at the 20th time step, images g202 and g252 indicate states at the 40th time step, images g203 and g253 indicate states at the time step, and images g204 and g254 indicate states at the 80th time step. In FIG. the horizontal axis represents the latent variable z (of eight values from 0 to 7) and the vertical axis represents the value of Q(s, a, z)-min_{z}(Q(s, a, z)).

Here, previous studies on option frameworks have reported that there is a possibility that only some options are activated and the remaining options are not useful as a problem with existing methods.

On the other hand, as shown in FIG. 15, the latent variable of z=4 maximizes the action value at the 20th time step, the latent variable of z=5 maximizes the action value at the 40th time step, the latent variable of z=3 maximizes the action value at the 60th time step, and the latent variable of z=3 maximizes the action value at the 80th time step. Thus, in the present embodiment, as in FIG. 15, the value of each lower policy changes over time, indicating that various lower policies are activated during execution. Accordingly, the method of the present embodiment can solve the problem of the known methods.

Next, an estimation error of the function will be described.

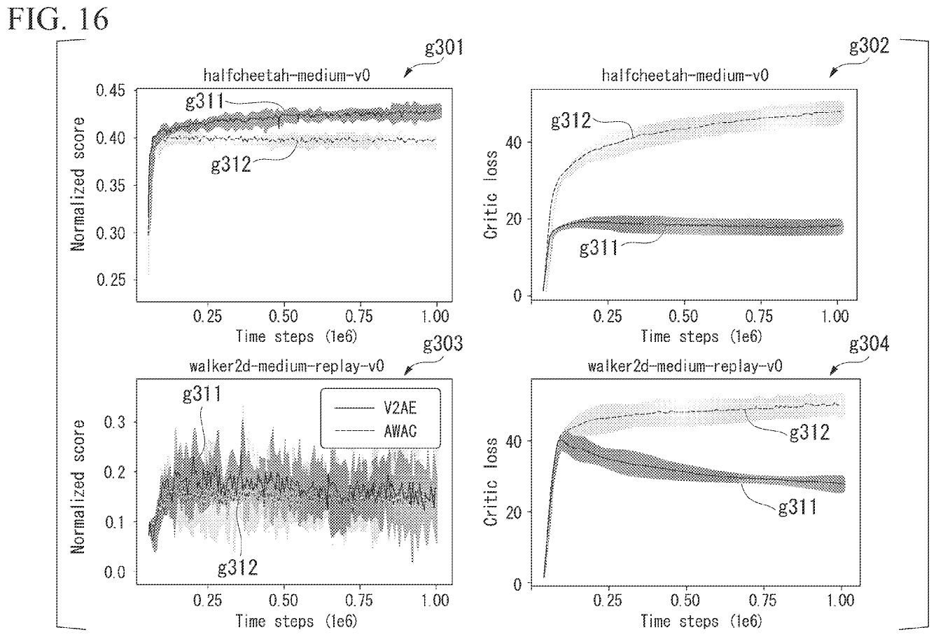

FIG. 16 is a diagram showing normalized scores and the values of a critic loss function when learning is performed using V2AE which is the method of the present embodiment and AWAC which is the method of the comparative example. In FIG. 16, the horizontal axis represents the time step (1e6) and the vertical axis represents the normalized score. In graphs g301 to g304, a line g311 indicates V2AE which is the method of the present embodiment and a line g312 indicates AWAC which is the comparative example. A graph g301 indicates the normalized score for halfcheetah-medium-v0. A graph g302 indicates the value of the critic loss function for halfcheetah-medium-v0. A graph g303 indicates the normalized score for walker2d-medium-replay-v0. A graph g304 indicates the value of the critic loss function for walker2d-medium-replay-v0. As the critic loss, the value of the critic loss given by expression (24) is plotted every 5000 updates.

Previous studies have shown that the estimation error of the Q function accumulates through repeated learning.

As shown in FIG. 16, it can be confirmed that function approximation errors accumulate in the known AWAC method which is a comparative example for the HalfCheetah's medium-v0 task. On the other hand, it can be seen from FIG. 16 that function approximation errors are definitely small in the V2AE method of the present embodiment and its policy performance is improved as compared with the AWAC method which is the comparative example.

The difference between the AWAC method which is the comparative example and the V2AE method of the present embodiment is the representation of the policy. Therefore, such results suggest that use of a mixed policy as in the present embodiment reduces the problem of accumulation of estimation errors of the Q function and improves the learning performance through the learning of the mixed policy.

As described above, the present embodiment uses the V2AE method for learning a mixed policy. The V2AE method of the present embodiment can be interpreted as an approach that divides the state-action space by learning a discrete latent variable and learns a lower policy corresponding to each region. From evaluation results, it was confirmed that the approach of the present embodiment can reduce the extrapolation error in offline reinforcement learning. It was also confirmed that the V2AE method of the present embodiment showed the best performance in some benchmark tasks of D4RL.

In this way, when the policy learned by the method of the present embodiment is executed, not all lower policies are activated, but a discrete latent variable is estimated according to the situation and a corresponding lower policy is sequentially selected and activated.

Thus, according to the present embodiment, when a dataset contains samples of various qualities, some latent variables are associated with samples of actions with poor performance and corresponding lower policies also perform poorly and therefore such lower policies are not activated during execution. Conversely, the information of high-performance action samples in the dataset is actively utilized according to the present embodiment.

According to the present embodiment, it was confirmed that learning a discrete variable and a mixed policy improved the learning performance Specifically, it was confirmed to outperform existing methods in some benchmark tasks of existing datasets that are called datasets for deep data-driven reinforcement learning (D4RL). Extrapolation errors and the problem of accumulating estimation errors in the value function have also been reduced.

In the following description, an example of offline reinforcement learning will be described, but the method and configuration of the present embodiment can also be applied online.

### Supplementary Description

### Proof of First Theorem

Here, a proof of the first theorem will be described. An operator T_{z} given by the following expression (33) will be considered.

$$\\ \begin{matrix}{𝒯}_{z} Q ( s , a ) = {𝔼}_{{s}^{′}} [ r ( s , a ) + γ {max}_{z} {Q}_{1} ( {s}^{′} , μ ( {s}^{′} , {z}^{′} ) ) ] & ( 33 )\end{matrix}$$

To prove the contractibility of T_{z}, infinity norms given by the following expressions (34) and (35) are used.

$$\\ \begin{matrix}{‖ {Q}_{1} - {Q}_{2} ‖}_{∞} = {max}_{s ∈ 𝒮 , a ∈ A} \vert {Q}_{1} ( s , a ) - {Q}_{2} ( s , a ) \vert & ( 34 )\end{matrix}$$

$$\\ \begin{matrix}{‖ {𝒯}_{z} {Q}_{1} - {T}_{z} {Q}_{2} ‖}_{∞} = \vert \begin{matrix}{𝔼}_{{s}^{′}} [ r ( s , a ) + γ {max}_{z} {Q}_{1} ( {s}^{′} , μ ( {s}^{′} , {z}^{′} ) ) ] - \\ {𝔼}_{{s}^{′}} [ r ( s , a ) + γ {max}_{z} {Q}_{2} ( {s}^{′} , μ ( {s}^{′} , {z}^{′} ) ) ]\end{matrix} \vert = \vert γ {𝔼}_{{s}^{′}} [ {max}_{z} {Q}_{1} ( {s}^{′} , μ ( {s}^{′} , {z}^{′} ) ) ] - {γ𝔼}_{{s}^{′}} [ {max}_{z} {Q}_{2} ( {s}^{′} , μ ( {s}^{′} , {z}^{′} ) ) ] \vert = γ \vert {𝔼}_{{s}^{′}} [ {max}_{z} {Q}_{1} ( {s}^{′} , μ ( {s}^{′} , {z}^{′} ) ) ] - {𝔼}_{{s}^{′}} [ {max}_{z} {Q}_{2} ( {s}^{′} , μ ( {s}^{′} , {z}^{′} ) ) ] \vert = γ \vert {𝔼}_{{s}^{′}} [ {max}_{z} {Q}_{1} ( {s}^{′} , μ ( {s}^{′} , {z}^{′} ) ) - {max}_{z} {Q}_{2} ( {s}^{′} , μ ( {s}^{′} , {z}^{′} ) ) ] \vert \leq γ \vert {𝔼}_{{s}^{′}} {‖ {Q}_{1} - {Q}_{2} ‖}_{∞} \vert \leq γ {‖ {Q}_{1} - {Q}_{2} ‖}_{∞} & ( 35 )\end{matrix}$$

### Additional Results Regarding Activation of Lower Policies

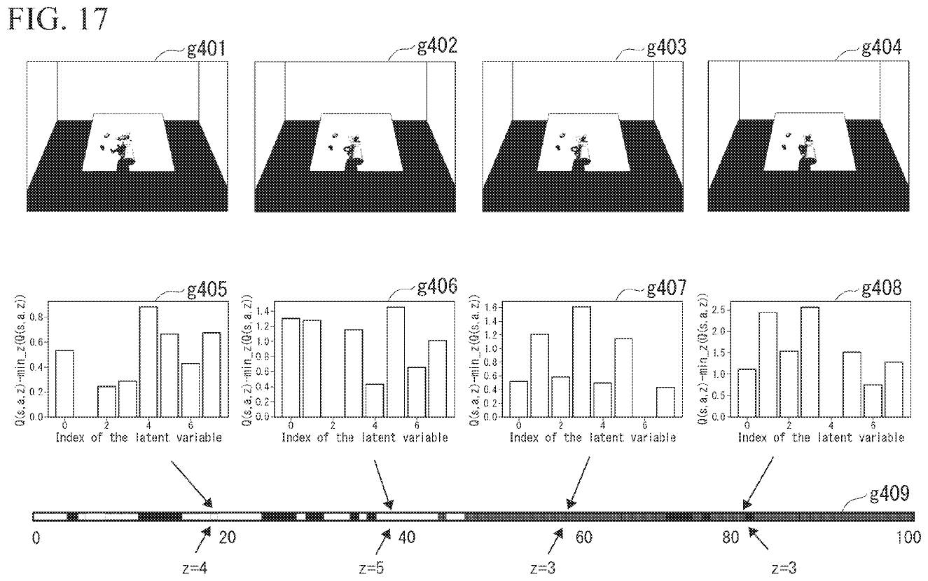

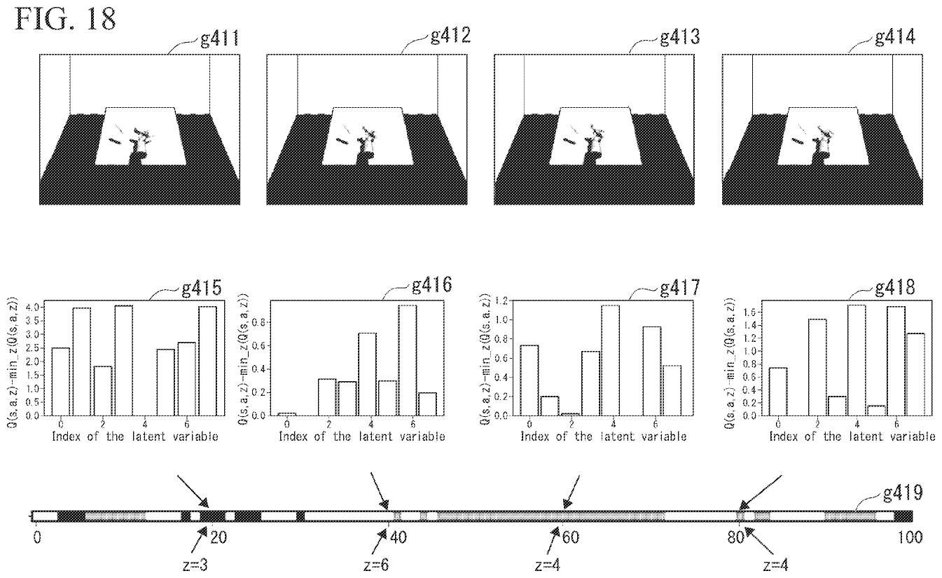

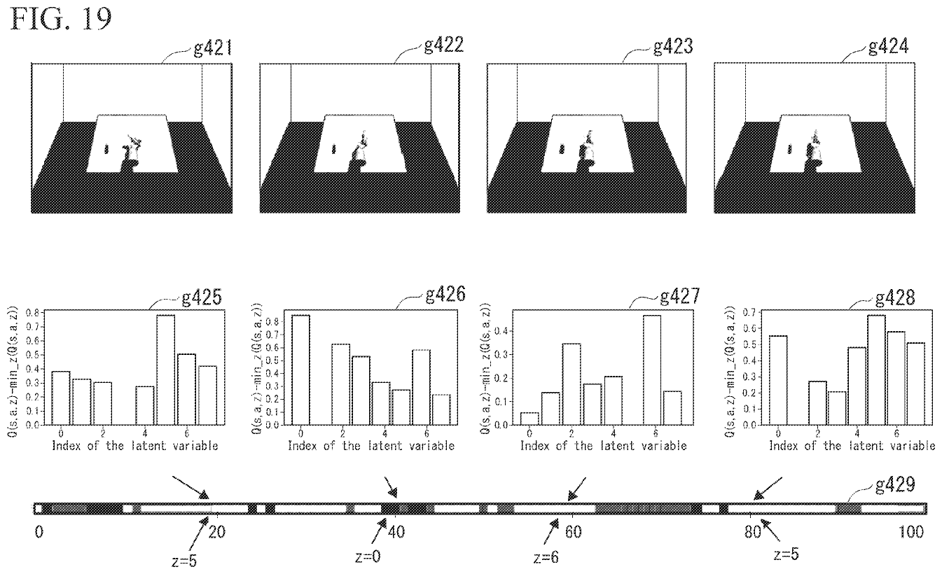

FIG. 17 is a diagram showing the results of a first episode of activation of lower policies in the pen-human-v0 task. FIG. 18 is a diagram showing the results of a second episode of activation of lower policies in the pen-human-v0 task. FIG. 19 is a diagram showing the results of a third episode of activation of lower policies in the pen-human-v0 task. In FIGS. 17 to 19, the horizontal and vertical axes of graphs g405 to g408, g415 to g418, and g425 to g428 are the same as those of FIG. 15. In FIGS. 17 to 19, images g401 to g404, g411 to g414, and g421 to g424 show the states of a hand and an object in the task. In FIGS. 17 to 19, the horizontal axis of images g409, g419, and g429 represents the sampling time. Images g409, g419, and g429 indicate the largest changes of the latent variable z at 20, 40, 60, and 80 time steps in the respective episodes. The same policies trained for 10,000 updates are used in FIGS. 17 to 19.

As shown in FIGS. 17 to 19, target poses of the object are different in the episodes and different lower policies (sub-policies) are activated to achieve the given targets. This qualitative results support the claim that different behaviors are encoded in the corresponding sub-policies.

### Hyperparameters and Implementation Details

Details of hyperparameters and implementation used in the evaluation will be described below.

In the evaluation, the author's implementation of each paper was used for TD3+BC, CQL, and EDAC.

easyBCQ and AWAC were independently implemented for fair comparison with the V2AE method of the present embodiment. Double clipped Q-learning was employed in the implementations of easyBCQ and AWAC.

In the V2AE method of the present embodiment, the policy is deterministic because both the upper policy π(z|s) and the lower policy π(a|s,z) are deterministic. Thus, the state value function is given by the following expression (36).

$$\\ \begin{matrix}{V}^{π} ( s ) = {max}_{z} {Q}^{π} ( s , μ ( s , z ) ) & ( 36 )\end{matrix}$$

Thus, the advantage function is given by the following expression (37).

$$\\ \begin{matrix}{A}^{π} ( s , a ) = {Q}^{π} ( s , a ) - {V}^{π} ( s ) = {Q}^{π} ( s , a ) - {max}_{z} {Q}^{π} ( s , μ ( s , z ) ) & ( 37 )\end{matrix}$$

A target actor in the second term of expression (36) was used in updating the policy. Therefore, the advantage function is approximated as in the following expression (37) in the implementation of the method of the present embodiment.

$$\\ \begin{matrix}A ( s , a ; w , {θ}^{′} ) = Q ( s , a ; w ) - {max}_{z} Q ( s , {μ}_{θ} , ( s , z ) ; w ) & ( 38 )\end{matrix}$$

All or a part of the process performed by the learning device 1 according to the present invention may be performed by recording a program for implementing some or all of the functions of the learning device 1 according to the present invention on a computer readable recording medium and causing a computer system to read and execute the program recorded on the recording medium. The “computer system” referred to here includes an OS or hardware such as peripheral devices. The “computer system” also includes a WWW system including a website providing environment (or display environment). The “computer readable recording medium” refers to a portable medium such as a flexible disk, a magneto-optical disc, a ROM, or a CD-ROM or a storage device such as a hard disk provided in a computer system. The “computer readable recording medium” includes one that holds the program for a certain period of time, like a volatile memory (RAM) provided in a computer system which serves as a server or a client when the program has been transmitted via a network such as the Internet or a communication line such as a telephone line.

The program may also be transmitted from a computer system in which the program is stored in a storage device or the like to another computer system via a transmission medium or by transmission waves in the transmission medium. Here, the “transmission medium” for transmitting the program refers to a medium having a function of transmitting information, like a network (a communication network) such as the Internet or a communication line (a communication wire) such as a telephone line. The program may be one for implementing some of the above-described functions. The program may also be a so-called differential file (differential program) which can implement the above-described functions in combination with a program already recorded in the computer system.

Although the mode for carrying out the present invention has been described above by way of embodiments, the present invention is not limited to these embodiments at all and various modifications and substitutions may be made without departing from the spirit of the present invention.

What is claimed is:

1. A learning device comprising:
a dataset acquisition unit configured to acquire a dataset including state information and action information on which a policy is to be learned;
a discrete latent variable estimation unit configured to estimate a discrete latent variable representing characteristics of features from the state information and the action information;
an optimal action learning unit configured to learn an optimal action using the state information and the discrete latent variable;
a value function estimation unit configured to learn an action value from the state information and the action information; and
an identification unit configured to identify the discrete latent variable that maximizes the action value using a result from the optimal action learning unit and a result from the value function estimation unit.

2. A learning method comprising:
an acquisition step of acquiring a dataset including state information and action information on which a policy is to be learned;
an estimation step of estimating a discrete latent variable representing characteristics of features of the dataset from the state information and the action information included in the dataset;
a first learning step of learning an optimal action using the state information and the estimated discrete latent variable;
a second learning step of learning an action value from the state information and the action information; and
an identification step of identifying the discrete latent variable that maximizes the action value using a result of learning of the first learning step and a result of learning of the second learning step.

3. The learning method according to claim 2, further comprising:
a value function update step of putting the identified discrete latent variable into the second learning step to update the value function;
a latent variable action update step of putting the updated value function into the estimation step and the first learning step to update the discrete latent variable and the optimal action; and
a third learning step of repeating the value function update step and the latent variable action update step to learn the discrete latent variable and the optimal action.

4. The learning method according to claim 2, wherein, when the learned policy is executed, not all the first learning steps are activated, the discrete latent variable is estimated according to a situation, and a lower policy corresponding to the estimated discrete latent variable is sequentially selected and activated.

5. The learning method according to claim 3, wherein, when z is the discrete latent variable, z′ is a next discrete latent variable, s is a state, s′ is a next state, Q_{w} is an estimate of a Q value parameterized by a vector w, y is a target value, r is a reward in learning, γ is a discount factor, θ is a vector representing parameters of a policy, ϕ is a vector representing parameters of a model of a posterior distribution, (z^{˜})′ is the next discrete latent variable that has been estimated, f^{π} is a function that quantifies performance of a policy π, l_{cvae} is a variational lower bound, and a is an action, the estimation step includes calculating the latent variable using
$$\\ {𝓏}^{′} = arg {max}_{{\tilde{𝓏}}^{′}} {Q}_{w} ( {s}^{′} , μ ( {s}^{′} , {\tilde{𝓏}}^{′} ) ) ,$$
the value function update step includes calculating the target value y using
$$\\ y = r + γ {min}_{j = 1 , 2} {Q}_{{w}_{j}} ( s , μ ( {s}^{′} , {𝓏}^{′} ) ) ,$$
the value function update step includes updating an action value function by updating a critic that minimizes Σ∥y− [symbol] _{w}(s,a)∥², and
the latent variable action update step includes updating a first model by updating an actor and a posterior distribution to maximize
$$\\ \{ ℒ ( θ , ϕ ) = {\sum }_{i = 1}^{N} {f}^{π} ( {s}_{i} , {a}_{i} ) {l}_{cvae} ( {s}_{i} , {a}_{i} ; θ , ϕ ) \} .$$
